(19) United States
(12) Patent Application Publication
(10) Pub. No.: US 2018/0319042 A1
(43) Pub. Date: Nov. 8, 2018

(54) A CLEANING PISTON WHICH HAS A NON-POLAR MATERIAL FOR A MIXING HEAD, AND MIXING HEAD AND DISCHARGE CHANNEL, EACH OF WHICH CONTAINS SUCH A CLEANING PISTON

(71) Applicant: KraussMaffei Technologies GmbH, 80997 München (DE)

(72) Inventor: JOSEF RENKL, Markt Indersdorf (DE)

(73) Assignee: KraussMaffei Technologies GmbH, 80997 München (DE)

(21) Appl. No.: 15/774,172

(22) PCT Filed: Nov. 9, 2016
(86) PCT No.: PCT/EP2016/077164

§ 371 Date: May 7, 2018

(30) Foreign Application Priority Data
Nov. 17, 2015 (DE) 10 2015 119 813.4

(51) Int. Cl. B29B 7/80; B29B 7/74; B29C 67/24

(52) U.S. Cl. CPC B29B 7/805; B29K 2075/00; B29C 67/246; B29B 7/7404

(57) ABSTRACT

A cleaning piston for a mixing head of a reaction moulding machine includes a main part which has a cylindrical casing region, and a clearing part. The material and geometry of the clearing part are designed to remove residual material adhering to a channel of the mixing head. The clearing part is at least partly made of non-polar material.

The invention relates to a cleaning piston for a mixing head of a reaction moulding machine (for the production of reaction plastics, such as polyurethane foams), with a main part having a cylindrical casing region, and a clearing part, the material and geometry of which is designed/disposed to remove residual material adhering to a (guide) channel (for the guiding of liquid components of the substance/material which is to be made available) of the mixing head. The invention furthermore relates to a mixing head which is preferably configured as a deflection mixing head, for a reaction moulding machine having such a cleaning piston. The invention also relates to a reaction moulding machine with, again, such a mixing head, and a discharge pipe (preferably able to be mounted on a housing of the mixing head so as to be removable again) of such a mixing head.

Cleaning pistons and mixing heads for reaction moulding machines having such cleaning pistons are already sufficiently known from the prior art. Thus, for example, DE 36 26 990 A1 discloses a device for the mixing of at least two reactive plastic components, in which a first and a second control- and cleaning piston are contained.

Therefore, it is already sufficiently known to configure mixing heads as self-cleaning deflection mixing heads, in which a discharge channel is arranged at an angle of approximately 90° to a mixing chamber. Through this arrangement, the outflowing mixture settles down, so that it can be discharged uniformly and cleanly. At the same time, the mixing chamber can be throttled to improve the mixtures in the case of the material components which are to be mixed. In particular in the case of chemical systems, such as PUR, i.e. polyurethanes, the adhering between bore/connecting channel and the discharge channel can be very greatly boosted. Such an adhering, as has been proved to be disadvantageous, is brought about in particular through the polarity of the steel materials. As a variety of chemical components can be processed on the same mixing head, problems arise repeatedly with the material pairings of the pistons (cleaning piston and control piston) and the bores (connecting channel and discharge channel). To date, it is therefore necessary to establish different fit tolerances and material pairings of the pistons for specific chemical components. This means that in particular different cleaning pistons or even different mixing heads have to be used for different applications of the mixing head for mixing different material components. The effort for conversion of the respective reaction moulding machine increases thereby considerably. The downtime of the respective reaction moulding machine is thereby likewise disadvantageously affected.

It is therefore the object of the present invention to eliminate these disadvantages known from the prior art and in particular to make available a mixing means which, on the one hand, is to be easy to clean, and on the other hand is to be adjustable as the least possible effort to the mixture which is to be produced.

This is solved according to the invention in that the clearing part of the cleaning piston is made at least partly of a non-polar material.

Through the use of a non-polar material on the cleaning piston, distinctly fewer material deposits occur during the operation of the mixing head owing to the lower cohesive forces. The cleaning piston, in particular in its clearing part, thereby remains free of mixture and with the desired geometry can carry out the cleaning work during the cleaning state. In particular, the friction force between cleaning piston and mixing head/discharge channel of the mixing head is thereby greatly reduced. Owing to the non-polar clearing part, the cleaning piston can also be used, at the same time, in a mixing head which is designed for different mixtures. Thereby, the effort for conversion is distinctly reduced.

Further advantageous embodiments are claimed in the subclaims and are explained in further detail below.

The clearing part can have an outer circumference which is at least partly greater relative to the casing region. The clearing part can therefore be at least partly expanded in circumference.

If is also advantageous if the clearing part has a casing made of/produced from a non-polar material. Thereby, the clearing part is produced with minimal effort.

In particular, it is advantageous if the casing is formed as a (preferably cap-shaped) top piece, which is held/fixed in a form-fitting, force-fitting and/or materially bonded manner on/against a receiving pin which is connected securely to the main part. Thereby, the production of the cleaning piston is carried out even more effectively.

Here it is advantageous in particular if a knurled structure is applied on the receiving pin, onto which knurled structure the clearing part in the form of the top piece is pushed with radial pre-stressing. Thereby, a fixed, force- and form-fitting connection is produced between the clearing part and the main part, wherein, however, an exchangeability of the clearing part is also possible.

When the non-polar material is a non-polar plastic material, such as a PIC- or a polyimide material, the clearing part is configured to be particularly wear-resistant. The clearing part is also able to be exchanged at a favourable cost.

If the main part is advantageously partly or even completely made of/produced from a metal material, preferably a ferrous or steel material, the cleaning piston is also configured to be particularly robust.

Alternatively hereto, the main part can be completely or additionally hereto partially made of/produced from a non-polar material. If the main part is made completely of a non-polar material, then the clearing part is preferably configured integrally with/being of one material with the main part. Thereby, the production of the cleaning piston becomes even more efficient. When the main part is partly made of/produced from a non-polar material, the non-polar material is preferably embodied as a coating or likewise as a sleeve/bush/top piece which is able to be put on.

When the clearing part has in addition on its outer casing side expediently at least one circumferential clearing groove in circumferential direction of the main part/clearing part, or a plurality of these (preferably equally wide and equally spaced) clearing grooves, a particularly effective clearing contour is implemented.

In this context, it is also advantageous if the clearing part has at least one sharp-edged contour, which is configured for removing the material adhering to the discharge pipe/discharge channel during operation. Thereby, the cleaning piston is operating particularly efficiently.

When the clearing part is arranged at an axial end region of the main part, with the formation of an axial face side of the cleaning piston, the cleaning of the mixing head/reaction moulding machine is further facilitated.

Furthermore, the invention also relates to a mixing head for a reaction moulding machine, which mixing head is preferably configured as a deflection mixing head, with a mixing chamber within which a control piston is arranged for regulating a component flow (preferably made of at least two components which are to be intermixed), a discharge channel (preferably running transversely to the mixing chamber and, in turn, joining onto this mixing chamber), and a cleaning piston, inserted in at least one cleaning state into the discharge channel, according to at least one of the previously described embodiments. Thereby, the mixing head is also configured per se to be particularly maintenance-friendly.

In this context, it is advantageous in addition if the discharge channel at least partly is made of/produced from a non-polar material. Thereby, shadings/adhesions on the part of the mixing head are also distinctly reduced.

If for this non-polar material of the discharge channel in turn a non-polar plastic substance/plastic material, such as a PIC- or a polyimide material, is used, the discharge channel is also repellent with respect to conventional mixture.

When the discharge channel is configured/formed in a housing/housing block of the mixing head made entirely of the non-polar material, the production of the mixing head can be further simplified.

When the discharge channel advantageously is made partly of the non-polar material in an axial guide region, in which guide region the clearing part of the cleaning piston is displaced/displaceable (axially) along in the cleaning state, the non-polar material is used particularly effectively.

It is also expedient if the discharge channel is formed partly by a bush (also designated discharge pipe) from the non-polar material. This bush is then preferably inserted into the housing of the mixing head, wherein the housing further preferably is made of a polar material, such as a metal material, namely ferrous material or respectively steel material. Thereby, the discharge channel is likewise configured particularly efficiently.

Therefore, to solve the previously designated problem, the invention also relates to a discharge pipe for a mixing head according to one of the previously described embodiments, which is disposed (with regard to material and/or geometry) for mounting on a housing of the mixing head, with the formation of a part of the discharge channel, and which discharge pipe is made at least partly of a non-polar material (preferably a non-polar plastic material, such as a PIC- or a polyamide material).

When the discharge channel partly is made of/produced from a polar material, such as a metal material, preferably a ferrous material such as a steel material, the outlet channel is configured to be particularly robust.

Furthermore, the invention also relates to a reaction moulding machine, with such a mixing head according to at least one of the previously described embodiments, whereby a reaction moulding machine can be operated per se particularly effectively.

The invention is now described in further detail below with the aid of figures, in which context also various example embodiments are explained.

There are shown:

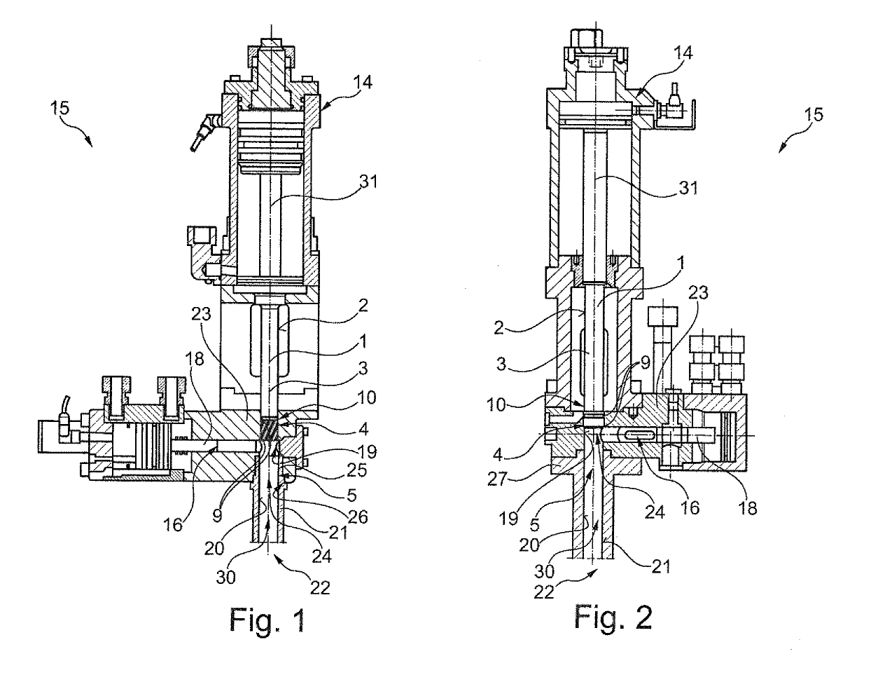

FIG. 1 a sectional illustration of a mixing head having a cleaning piston according to the invention in accordance with a preferred first example embodiment, wherein the mixing head is illustrated in section along the discharge channel and along the mixing chamber,

FIG. 2 a sectional illustration of a mixing head with a cleaning piston according to the invention in accordance with a second example embodiment, wherein this mixing head differs compared to the mixing head of FIG. 1 in particular by the cleaning piston and by a bush also forming the outlet channel,

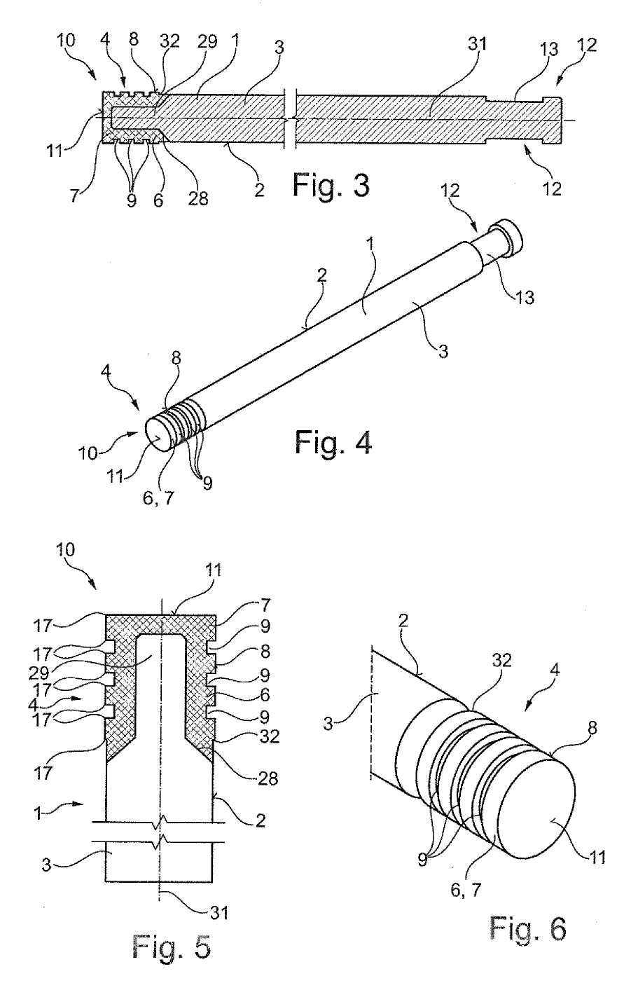

FIG. 3 a longitudinal section illustration of a cleaning piston according to the invention in accordance with a third example embodiment, in which a preferred structure of the cleaning piston is illustrated particularly well, wherein this cleaning piston is in turn able to be inserted into a mixing head of FIG. 1 or 2,

FIG. 4 a perspective illustration of the cleaning piston according to FIG. 3 in a full view,

FIG. 5 a detail illustration of the end region of the cleaning piston according to FIG. 3, in section in longitudinal direction, wherein a cleaning part can be seen in its configuration and arrangement,

FIG. 6 a perspective illustration of the cleaning piston, illustrated in full view, according to FIG. 4, in the region of the clearing part,

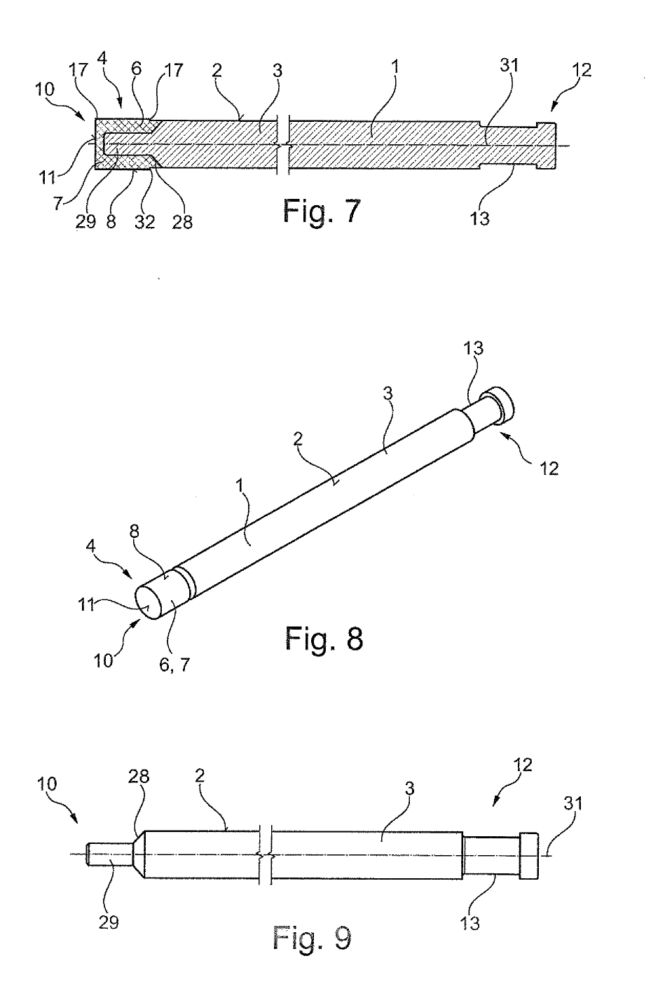

FIG. 7 a longitudinal section illustration of a cleaning piston according to a further fourth example embodiment, which cleaning piston is in turn able to be inserted into a mixing head of FIG. 1 or 2, and now on its outer circumference side is not grooved on the circumference like the cleaning piston according to FIGS. 3 to 6, but rather has a non-grooved outer casing side,

FIG. 8 a perspective illustration of the cleaning piston according to FIG. 7 in a full view, and

FIG. 9 a side view of a main part, as is inserted into the cleaning piston of FIGS. 1 to 8.

The figures are only diagrammatic in nature and serve exclusively for the understanding of the invention. The same elements are provided with the same reference numbers.

In FIG. 1 firstly a mixing head 15 according to the invention can be clearly seen in accordance with a preferred first example embodiment. The mixing head 15 is configured/provided as a mixing head 15 of a reaction moulding machine and therefore for use/connection in/to this reaction moulding machine, which for reasons of clarity is not illustrated further here. In particular, the mixing head 15 serves, in an operation of the reaction moulding machine, for homogenizing/intermixing/blending at least two different individual components of a reaction plastic. For example, the mixing head 15 is used for producing a polyurethane material, namely a polyurethane foam/PUR foam.

The mixing head 15 is furthermore configured as a deflection mixing head. The mixing head 15 has an elongated mixing chamber 16. A control piston 18 is received displaceably in the mixing chamber 16. Depending on the location/position of this control piston 18 in the mixing chamber 16, the individual components (in a conveying position of the control piston 18) of the reaction plastic/the mixture which is to be provided are introduced into the mixing chamber 16 or (in a locked position of the control piston 18) are prevented from flowing into the mixing chamber 16. The mixing chamber 16, extending in a straight line, is aligned/running transversely, namely perpendicularly/by 90° to a discharge channel 5. The mixing chamber 16 continues into this discharge channel 5, is therefore connected to the discharge channel 5.

In a conveying/mixing state of the mixing head 15, the control piston 18 is connected in its conveying position, and the discharge channel 5 is opened toward the environment of the mixing head 15. Thereby, the mixture flows in the fluid state, after exiting from the control piston 18, through the mixing chamber 16 and the discharge channel 5, up to an outlet opening 22 of the discharge channel 5. At this outlet opening 22 the mixture exits from the mixing head 15 and is fed in a conventional manner to further devices for hardening/cooling/forming of a completed semi-finished product. In a locked position of the control piston 18, then in turn a flowing of the individual components from the control piston 18 into the mixing chamber 16 and thereby finally also a flowing of the mixture from the mixing chamber 16 into the discharge channel 5 is prevented. This locked position of the control piston 18 is implemented, for instance, when the discharge channel 5 is to be cleaned/cleared owing to residual material/moulding residues adhering to it.

For cleaning the mixing head 15 in a so-called cleaning state of the mixing head 15/of the reaction moulding machine, the control piston 18 is brought into its locked position, and a cleaning piston 1, inserted in the discharge channel 5, is displaced in axial direction, so that it conveys the adherent, excess residual material out from the discharge channel 5 and prepares the discharge channel 5 for a new mixing process/mixing state.

As the discharge channel 5, which likewise extends in a straight line, runs transversely, namely perpendicularly to the mixing chamber 16, the cleaning piston 1 is aligned transversely, namely substantially perpendicularly to the control piston 18, and is displaceable in its axial direction (along its longitudinal axis).

The discharge channel 5, as can also be seen particularly well in FIG. 1, is formed in a first part/section through a wall 19/inner wall of a hole/bore 24 in a housing 23 of the mixing head 15. In a second part/section, which adjoins the first part in longitudinal direction of the discharge channel 5, the discharge channel 5 is formed by an inner circumferential side 20 of a bush 21. The bush 21 is, in turn, fastened to the housing 23. Both the wall 19 and also the bush 21 form a guide region 30 of the discharge channel 5 which, during operation of the reaction moulding machine, comes in contact with mixture and directs the mixture towards the outlet opening 22. In other words, the bush 21 therefore forms a discharge pipe and is also alternatively designated as such in the following.

The discharge channel 5 is made partly of a non-polar material. In particular, in this embodiment, the bush 21 is produced (entirely) from this non-polar material in the form of a non-polar plastic material, namely a polyimide material, alternatively also a PIC material. Thereby, the discharge channel 5 has a non-polar material in particular on a radial inner side/the inner circumferential side 20 of the bush 21. Therefore, the bush 21 is repellent with respect to residual material from the reaction plastic/mixture of the (plastic) individual components which is to be blended.

The housing 23 of the mixing head 15, in which the first part of the discharge channel 5 is formed in the form of the bore 24, is made in turn, in this embodiment, of a polar material, namely a steel material. Alternatively hereto, it is also possible in principle to produce this housing 23 and therefore the bore 24 from a different metal material, or likewise from a non-polar material. In other words, the bore 24 and the bush 21 form respectively sections in which the cleaning piston 1 moves along in the cleaning state. In particular, the non-polar material properties of the bush 21 makes provision that excess material components/residual material adhere less intensively, or not at all, to the discharge channel 5.

The bush 21, as can likewise be readily seen in FIG. 1, is formed with a threaded section 25 at an axial end. This threaded section 25 is screwed directly into an internal threaded region 26 of the housing 23, so that the bush 21 is securely screwed to the housing 23, in a manner aligned coaxially to the bore 24. The bush 21 is therefore mounted on the mixing head 15/housing 23 of the mixing head 15 so as to be removable again.

According to a second example embodiment of a mixing head 15 according to FIG. 2, it is also possible to dispense with such a threaded section 25 on the bush 21 itself. Instead of the threaded section 25, the bush 21 is provided with a flange region 27, which in turn is connected to the housing 23 so as to be removable again. The flange region 24 is mounted on the housing 23 by means of a plurality of screws or similar detachable fastening means. Also in this embodiment, the bush 21 is always aligned coaxially to the bore 24 and to the cleaning piston 1. The remaining structure and the mode of operation of this mixing head 15 correspond to the mixing head of the first example embodiment.

With respect to the cleaning piston 1 of the first example embodiment, and to the cleaning piston 1 of the second example embodiment, firstly the cleaning piston 1, illustrated in further detail in FIGS. 3 to 6, of a third example embodiment is now firstly described in detail in the following, wherein the cleaning pistons 1 used in the first and second example embodiments function and are constructed to the greatest possible extent like the cleaning piston 1 according to FIGS. 3 to 6.

The cleaning piston 1 according to the invention has, as clearly illustrated in FIG. 3, a rod-shaped main part 3. The rod-shaped main part 3 can also be readily seen alone in FIG. 9. The main part 3 has a cylindrical casing region 2. The casing region 2 has a uniform/constant diameter over its length/along a longitudinal axis 31 of the cleaning piston 1. The main part 3 also is made entirely of a polar material, namely of a metal material in the form of a steel material. In other embodiments, however, the main part 3 is also produced from a non-polar material, such as a non-polar plastic material such as PIC or polyamide.

At its respective end regions 10 and 12, the main part 3 is reduced/narrowed in diameter. At a first end region 10, the diameter is reduced with respect to the casing region 2 by a radial shoulder 28. This region, reduced in (outer) diameter, of the main part 3 forms a receiving pin 29. At a second end region 12, lying opposite the first end region 10, the main part 3 is likewise partly narrowed/reduced in (outer) diameter with respect to the casing region 2, and has a fully circumferential connecting groove 13 in circumferential direction of the cleaning piston 1. During operation of the mixing head 15, a drive means engages into the connecting groove 13, in order to displace the cleaning piston 1, in the cleaning state, axially to and fro.

At the first end region 10 furthermore a cleaning part 4 of the cleaning piston 1 is formed/arranged/configured. The clearing part 4 is configured with regard to material and geometry for removing the moulding residues adhering to/in the discharge channel/channel 5 of the mixing head 15. The clearing part 4 includes on the one hand of the receiving pin 29, embodied in one piece with the main part 3 with regard to material, on the other hand of a top piece 7 which is separate from the main part 3 with regard to material. The top piece 7 is placed securely onto the receiving pin 29. The top piece 7 is formed in a cap-shaped manner and forms both a casing 6 with regard to the main part 3/receiving pin 29 and also an axial face side 11 of the cleaning piston 1. Therefore, the clearing part 4 is pushed onto the main part 3 and forms over a certain longitudinal region of the cleaning piston 1 its outer casing side 8.

The top piece 7/casing 6 is made entirely of a non-polar material. In this embodiment, the top piece 7/casing 6 is also made of a non-polar plastic material, namely a polyamide material, alternatively of a PIC material.

In the example embodiment according to FIGS. 3 to 6, the clearing part 4 is provided with several, namely three, clearing grooves 9 running continuously around along the circumference of the cleaning piston/main part 3. The clearing grooves 9 are introduced into the outer casing side 8 of the top piece 7. The clearing grooves 9 are arranged next to one another spaced apart uniformly in axial direction. Through these clearing grooves 9, in turn, a plurality of sharp-edged contours 17 are formed. By means of these contours 17/edges, the clearing part 4, in the cleaning state, scrapes off the residues on the discharge channel 5. The outer casing side 8 is also shouldered/enlarged in its circumference relative to the casing region 2. The outer casing side 8 is partly increased in diameter with respect to the diameter of the casing region 2. Also through a shoulder 32 which is thus formed, a sharp edge/sharp-edged contour 17 is formed for the scraping of the channel 5. Likewise, such a sharp-edged contour 17 is formed on the radial exterior of the face side 11. Sharp-edged with respect to the contours 17 is understood to mean here that these respective edges, arranged in the radial outermost region of the outer casing side 8 have an edge radius of a maximum of 0.5 mm, preferably of approximately 0.2 mm.

In FIG. 5 it can also be readily seen how the top piece 7 in the form of the casing 6 in this example embodiment is placed/fastened in a form- and force-fitting manner on the receiving pin 29 of the main part 3. The main part 3 has on its outer circumferential side in the region of the receiving pin 29 a knurl/knurled surface structure, which is in contact with the inner circumferential side of the top piece 7/casing 6. Thereby, the connecting force between top piece 7 and main part 3 is further increased in axial direction of the cleaning piston 1.

The cleaning piston 1 (in the cleaning state) is displaceable in the discharge channel 5 of the mixing head so far in axial direction that it can always be pushed with the clearing part 4 through the entire guide region 30, i.e. both through the entire wall 19 and also through the entire bush 21.

In FIGS. 7 and 8, a further example embodiment of a cleaning piston 1 according to the invention is then in turn illustrated further, wherein this example embodiment is embodied in principle like the example embodiment of the cleaning piston 1 according to FIGS. 3 to 6. In this embodiment, only the clearing grooves 9 are dispensed with, and the clearing part 4 has, adjacent to the shoulder 32, a substantially smooth/cylindrical outer casing side 8. Here, also, the top piece 7 again forms a face side 11 of the cleaning piston 1.

Returning to FIGS. 1 and 2, it is also possible in principle to configure the cleaning piston 1 still differently in the region of the clearing part 4.

In FIG. 1 the cleaning piston 1 according to the invention is configured on the outer casing side 8 of the top piece 7 with clearing grooves 9 running in a spindle-shaped/helical/spiral-shaped manner.

It is also possible, according to the cleaning piston 1 according to the invention, in accordance with FIG. 2, to configure the clearing part 4 with a different number of clearing grooves 9 than with the three clearing grooves 9 implemented in FIG. 4. In FIG. 2 only two clearing grooves 9 are implemented.

Further, the control piston 18 of the mixing head 15 has e.g. a diameter of approximately 16 mm, the cleaning piston 1 has a diameter e.g. of approximately 25 mm. The pistons (control piston 18 and cleaning piston 1) are respectively produced with specific steel materials and are subjected to particular surface treatments.

In other words, the cleaning piston 1 can therefore be produced as a whole with a non-polar substance/material and in the front region can be equipped with different geometries. The cleaning piston can also be produced in the front region with a non-polar material and with different geometries. The non-polar material in the front region of the piston can be embodied with the most varied geometries. The discharge pipe (bush 21/discharge channel 5) can be produced as a whole with a non-polar material. The discharge pipe 5 can be produced in particular with a bush 21 with non-polar material. The discharge pipe 5 can, however, also be produced, at least partly, with a polar material (e.g. steel). Therefore, combinations of polar and non-polar materials can be used for the piston 1 and the discharge pipe 5. The fit tolerances are relatively non-critical here, because the non-polar materials (in particular in radial direction) are pre-stressed. Through the pre-stressing of the non-polar material (e.g. PIC, polyamide, etc.)/the pre-stressing of the clearing part 4 in the discharge pipe 5 in radial direction, the discharge pipe 5 can be cleaned in a residue-free manner.

### LIST OF REFERENCE NUMBERS

1 cleaning piston
3 casing region
3 main part
4 clearing part
5 channel/discharge channel
6 casing
7 top piece
8 outer casing side of the clearing part
9 clearing groove
10 first end region
11 face side
12 second end region
13 connecting groove
14 drive means
15 mixing head
16 mixing chamber
17 contour
18 control piston
19 wall
20 inner circumferential side
21 bush
22 discharge opening
23 housing
24 bore
25 threaded section
26 internal threaded region
27 flange region
28 shoulder/first shoulder
29 receiving pin
30 guide region
31 longitudinal axis
32 shoulder/second shoulder

1.-13. (canceled)

14. A cleaning piston for a mixing head of a reaction moulding machine, said cleaning piston comprising:
a main part having a cylindrical casing region; and
a clearing part made of a non-polar material and having a geometry reflective of a sharp-edged contour so as to remove residual material adhering during operation to a channel of the mixing head.

15. The cleaning piston of claim 14, wherein the clearing part has an outer circumference sized at least partly greater in relation to the casing region.

16. The cleaning piston of claim 14, wherein the clearing part has a casing made of non-polar material.

17. The cleaning piston of claim 16, further comprising a receiving pin connected securely to the main part, said casing being formed as a top piece, which is held in a form-fitting, force-fitting and/or materially bonded manner on the receiving pin.

18. The cleaning piston of claim 14, wherein the non-polar material is a non-polar plastic material.

19. The cleaning piston of claim 14, wherein the main part is made entirely or partly of a ferrous material.

20. The cleaning piston of claim 14, wherein the main part is made entirely or partly of a non-polar material.

21. The cleaning piston of claim 14, wherein the clearing part has an outer casing side provided with a circumferential clearing groove or a plurality of clearing grooves in a circumferential direction of the main part.

22. The cleaning piston of claim 14, wherein the clearing part is arranged at an axial end region of the main part and forms an axial face side.

23. A mixing head for a reaction moulding machine, comprising:
a mixing chamber;
a control piston arranged in the mixing chamber for regulating a component flow;
a discharge channel; and
a cleaning piston inserted into the discharge channel in at least one cleaning state, said cleaning piston including a main part having a cylindrical casing region, and a clearing part made of a non-polar material and having a geometry reflective of a sharp-edged contour so as to remove residual material adhering during operation to a channel of the mixing head.

24. The mixing head of claim 23, wherein the discharge channel is made at least partly of a non-polar material.

25. The mixing head of claim 23, wherein the clearing part has an outer circumference sized at least partly greater in relation to the casing region.

26. The mixing head of claim 23, wherein the clearing part has a casing made of non-polar material.

27. The mixing head of claim 26, wherein the cleaning piston includes a receiving pin connected securely to the main part, said casing being formed as a top piece, which is held in a form-fitting, force-fitting and/or materially bonded manner on the receiving pin.

28. The mixing head of claim 23, wherein the non-polar material is a non-polar plastic material.

29. The mixing head of claim 23, wherein the main part is made entirely or partly of a ferrous material or a non-polar material.

30. The mixing head of claim 23, wherein the clearing part has an outer casing side provided with a circumferential clearing groove or a plurality of clearing grooves in a circumferential direction of the main part.

31. The mixing head of claim 23, wherein the clearing part is arranged at an axial end region of the main part and forms an axial face side.

32. A reaction moulding machine, comprising a mixing head, said mixing head including a mixing chamber, a control piston arranged in the mixing chamber for regulating a component flow, a discharge channel, and a cleaning piston inserted into the discharge channel in at least one cleaning state, said cleaning piston including a main part having a cylindrical casing region, and a clearing part made of a non-polar material and having a geometry reflective of a sharp-edged contour so as to remove residual material adhering during operation to a channel of the mixing head.

33. A discharge pipe for a mixing head, said discharge pipe constructed for attachment onto a housing of the mixing head such as to form a section of a discharge channel, said discharge pipe being made at least partly of a non-polar material.
